(19) United States
(12) Patent Application Publication
(10) Pub. No.: US 2022/0372829 A1
(43) Pub. Date: Nov. 24, 2022

(54) MALE-MALE HOT STAB ASSEMBLY

(71) Applicant: VETCO GRAY SCANDINAVIA AS, Nailsea (GB)

(72) Inventor: Tom Ståle HELLAND, Stord (NO)

(21) Appl. No.: 17/753,770

(22) PCT Filed: Sep. 18, 2020
(86) PCT No.: PCT/EP2020/025422

§ 371 Date: Mar. 14, 2022

(30) Foreign Application Priority Data
Sep. 19, 2019 (NO) 20191137
Jun. 23, 2020 (NO) 20200733

(51) Int. Cl. E21B 33/035; F16L 1/26

(52) U.S. Cl. CPC E21B 33/0387; F16L 1/26

(57) ABSTRACT

A male-male hot stab assembly connectable to a flying receptacle is described. The male-male hot stab assembly comprises a first hot stab comprising a first hot stab male front end and a first hot stab base end, a second hot stab comprising a second hot stab male front end and a second hot stab base end, where the first hot stab and second hot stab are connected to each other by connecting the first hot stab base end to the second hot stab base end. In addition, a flying receptacle configured to receive a first hot stab of the hot stab assembly is described, which comprises a receptacle first end, configured to receive a first hot stab, a channel allowing the first hot stab to be inserted into the flying receptacle, a receptacle second end, and an ROY-handle. Further described is a subsea fluid connection system.

### TECHNICAL FIELD

The present invention relates to the field of subsea hydraulics, in particular to the field of subsea hot stab connectors.

### BACKGROUND OF THE INVENTION

A hot stab is a subsea hydraulic coupling that inter alia may be used to transmit hydraulic fluid to power subsea equipment. A hot stab typically has a rod-like body that comprises a male front end connectable to subsea equipment, and a base end that is connectable to a hydraulic power provider. The connection with a hydraulic power supplier may be provided using a standard hose, conduit or similar. A hot stab may be manufactured in accordance with industry standards (e.g. ISO 13628-8, API 17 H).

A hot stab male front end comprises fluid openings that are connected to fluid channels arranged inside the hot stab body. The fluid channels connect the male front end fluid openings to openings located on the base end that further may be connected to the hydraulic power provider. The male end of a hot stab may in various applications be sectioned in order to allow one hot stab connection to power a plurality of subsea equipment. Each section may then deliver power to individual subsea equipment, and thus be sealed off from each other using for example O-rings.

A problem with current hot stabs is that the O-rings that seal various sections of the male portion of a hot stab need to be changed. The replacement of a hot stab O-ring usually involves lifting large subsea installations connected to the hot stab to the surface.

It is a goal of the current invention to provide a hot stab assembly that facilitates for less time-consuming maintenance.

### SUMMARY OF THE INVENTION

A first aspect of the present invention provides a male-male hot stab assembly connectable to a flying receptacle, the male-male hot stab assembly comprising; a first hot stab comprising a first hot stab male front end and a first hot stab base end, and a second hot stab comprising a second hot stab male front end and a second hot stab base end, where the first hot stab and second hot stab are connected to each other by connecting the first hot stab base end to the second hot stab base end.

According to an embodiment of the invention fluid connection between the first hot stab and the second hot stab is provided using conduits.

According to another embodiment of the invention the first hot stab further comprises a first hot stab base end fluid opening, and the second hot stab further comprises a second hot stab base end fluid opening, wherein the first hot stab base end fluid opening is aligned with the second hot stab base end fluid opening.

According to yet another embodiment of the invention the male-male hot stab assembly comprises a connector plate comprising a connector plate front face and a connector plate rear face, where the first hot stab and second hot stab are connected to each other by connecting the first hot stab base end to the second hot stab base end via the connector plate.

According to yet another embodiment of the invention the connector plate is provided with a connector plate fluid passage that extends through the connector plate from a first fluid passage opening on the connector plate front face to a second fluid passage opening on the connector plate rear face, and where the first and second connector plate fluid passage openings are aligned with the first hot stab base end fluid opening, and the second hot stab base end fluid opening respectively.

According to yet another embodiment of the invention the connector plate is provided with a fluid seal around the first fluid passage opening and a fluid seal around the second fluid passage opening.

According to yet another embodiment of the invention the male-male hot stab assembly comprises an ROV handle. The ROV handle may be connected to the connector plate.

According to yet another embodiment of the invention the connector plate extends in a lateral direction relative to a central longitudinal axis of the male-male hot stab assembly, where the ROV handle is connected to the connector plate in a direction parallel to the central longitudinal axis of the male-male hot stab assembly, and at a lateral distance from the central longitudinal axis of the male-male hot stab assembly.

A second aspect of the present invention provides a flying receptacle, configured to receive a first hot stab of a hot stab assembly, where the receptacle comprises a receptacle first end, configured to receive a first hot stab, a channel allowing the first hot stab to be inserted into the flying receptacle, a receptacle second end, and an ROV-handle.

According to an embodiment of the invention the flying receptacle comprises ventilation means configured to release pressure from within the receptacle when a hot stab is received by the receptacle.

According to another embodiment of the invention the ROV-handle is connected to the receptacle second end.

According to yet another embodiment of the invention the flying receptacle comprises a flex joint connected between the ROV handle and the receptacle second end.

According to yet another embodiment of the invention the flying receptacle comprises a spacer provided between the ROV-handle and the receptacle second end, where the spacer is configured to release pressure from within the receptacle when a hot stab is received by the receptacle. The spacer may have a tubular shape provided with at least one fluid passage.

A third aspect of the present invention provides subsea fluid connection system comprising: a subsea installation, comprising a fixed receptacle, a male-male hot stab assembly, and a flying receptacle, where the second hot stab of the male-male hot stab assembly is configured to connect to the fixed receptacle and where the first hot stab of the male-male hot stab assembly is configured to connect to the flying receptacle.

Other advantageous features will be apparent from the accompanying claims.

### BRIEF DESCRIPTION OF DRAWINGS

FIG. 1 is a schematic representation of a male-male hot stab assembly according to an embodiment of the invention,

FIG. 2 is a schematic representation of a subsea fluid connection system according to an embodiment of the invention,

FIG. 3 is a schematic representation of a subsea fluid connection system according to an embodiment of the invention, and

FIG. 4 is a schematic representation of a male-male hot stab assembly according to an embodiment of the invention where the male-male hot stab assembly comprises a first hot stab base end fluid opening and a second hot stab base end fluid opening.

### DETAILED DESCRIPTION

In the following, general embodiments as well as particular exemplary embodiments of the invention will be described. Optional references will be made to the accompanying drawings. It shall be noted that the drawings are exemplary embodiments only, and that other features and embodiments may well be within the scope of the invention as claimed.

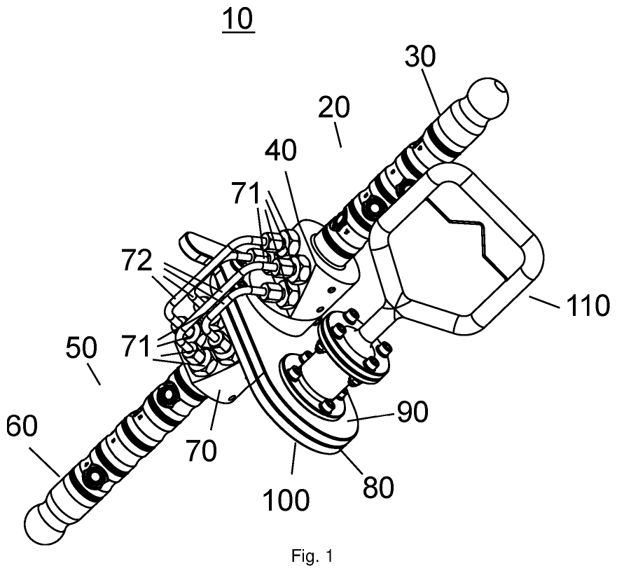

A first aspect of the present invention relates to a hot stab assembly 10. The hot stab assembly 10 may be defined as a male-male hot stab assembly 10 that comprises a first hot stab and a second hot stab 50, where the first hot stab 20 and the second hot stab 50 are connected to form the male-male hot stab assembly 10. Each hot stab comprises according to the invention a base end 40,70 and a hot stab male end 30,60. The male-male hot stab assembly 10 is according the invention formed by connecting the base end 40 of the first hot stab 20 with the base end 70 of the second hot stab 50. Examples of a hot stab assembly 10 may be seen in FIGS. 1 - 4.

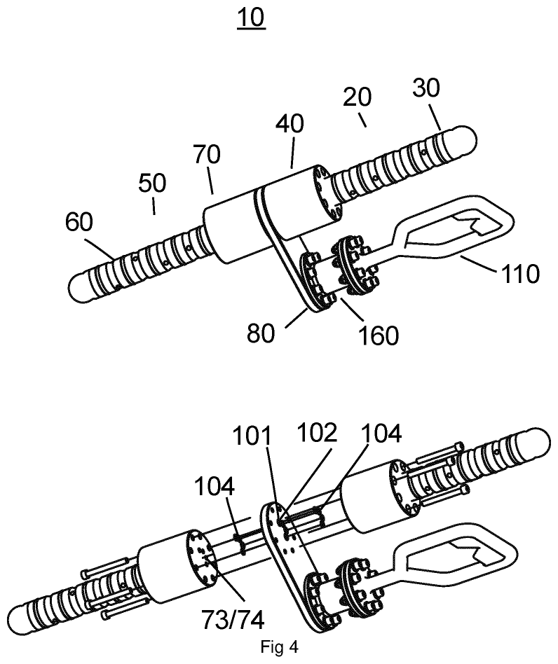

The base end 40, 70 of each hot stab may according to the invention be provided with fluid openings 71. These openings may be conventional fluid openings 71 configured to be connected to hoses carrying hydraulic, or may alternatively be openings at the base surface of the hot stab base end 40, 70. Fluid connection may in one embodiment of the invention be provided between the first hot stab 20 and the second hot stab 50 using conduits 72 such as hoses/tubes that may be used to connect the conventional fluid openings 71 of the first hot stab 20 with fluid openings 71 of the second hot stab 50. These tubes may be steel tubes. The fluid connection allows for fluid entering through a fluid opening 71 in a first hot stab male portion 30 to be transferred to the second hot stab 50. An example of a male-male hot stab assembly 10 where each hot stab is provided with one or more fluid openings 71 at their base end 40, 70 is schematically illustrated in FIG. 1. Fluid openings 71 may alternatively be fluid openings at the base surface/base end face of the hot stab base end 40, 70, as is schematically illustrated in FIG. 4. It will be appreciated by a person skilled in the art that a fluid opening in the context of the present invention may be called by different terms, e.g. a fluid port.

The hot stab male end may be a conventional hot stab male end that comprises fluid openings and fluid channels that are arranged inside the hot stab male end. The fluid channels may thus be used to connect the male end fluid openings with fluid openings on the base end.

The first hot stab 20 may according to one embodiment of the invention further comprise a first hot stab base end fluid opening 73. The second hot stab 50 further may equivalently comprise a second hot stab base end fluid opening 74.The connection of the first hot stab 20 with the second hot stab 50 may here be performed such that the base end fluid openings 73 of the first hot stab 20 are aligned with the base end fluid openings 74 of the second hot stab 50. This will thereby provide a fluid connection between the first hot stab 20 and the second hot stab 50. Said connection may as schematically illustrated in FIG. 4 be provided between the first hot stab base end fluid opening 73 and the second hot stab base end fluid opening 74 by aligning the two hot stabs such that the two base end fluid ports are facing one another. Said openings may in FIG. 4 be seen as provided at the base surface/base end face of the hot stab base end 40, 70 of each hot stab.

A connector plate 80 is according to one embodiment of the invention inserted between the base end 40 of the first hot stab 20 and the base end 70 of the second hot stab 50. This connector plate 80 may be used to facilitate connection of the first hot stab 20 and the second hot stab 50. The connection may for example be performed using various fastening means, like screws, clamps or other suitable means. The connector plate 80 has a plane shape with a connector plate front face 90 and a connector plate rear face 100, where the base end 40 of the first hot stab 20 faces the connector plate front face 90 and the base end 70 of the second hot stab 50 faces the connector plate rear face 100. Alternatively, the other way around. FIGS. 1-4 illustrate an example of a male-male hot stab assembly 10 where a connector plate 80 is inserted between the base end 40 of the first hot stab 20 and the base end 70 of the second hot stab 50.

The connector plate 80 is according to one embodiment of the invention provided with a connector plate fluid passage 101 that extends through the connector plate 80. The fluid passage 101 may extend from a first fluid passage opening 102 on the connector plate front face 90 to a second fluid passage opening 103 on the connector plate rear face 100. The connector plate fluid passages may be aligned with the base end fluid openings of the first hot stab and the second hot stab. A fluid connection may thus, as illustrated in FIG. 4, be provided between the first hot stab 20, through the connector plate 80, and into the second hot stab 50, thus allowing fluid flow through the male-male hot stab assembly 10.

The connector plate 80 is according to one embodiment of the invention provided with a fluid seal 104 around the first fluid passage opening 102 and a fluid seal 104 around the second fluid passage opening 103. The fluid seal 104 may be provided by providing a recess in the connector plate 80 that may further be provided with an O-ring. The recess may in this example be provided in a distance from the fluid passage opening, e.g. 1-2 mm away. A fluid connection is in this embodiment provided between the first hot stab 20, through the connector plate 80, and into the second hot stab 50, thus allowing fluid flow through the male-male hot stab assembly 10. An example of a connector plate 80 provided with a fluid seal 104 around the first fluid passage opening 102 and a fluid seal 104 around the second fluid passage opening 103 of a connector plate fluid passage 101 is schematically illustrated in FIG. 4.

The connector plate 80 may according to one embodiment of the invention extend in a lateral direction relative to a central longitudinal axis of the male-male hot stab assembly 10. The central longitudinal axis of the male-male hot stab assembly 10 can here be seen as the axis that goes longitudinally through the central portion of the male parts of the first and second hot stab 50. The central longitudinal axis extends in other words longitudinally through the centre of the first hot stab 20 and the centre of the second hot stab 50. FIGS. 1-4 illustrate an example of a male-male hot stab assembly 10 where the connector plate 80 extends in a lateral direction relative to a central longitudinal axis of the male-male hot stab assembly 10.

The connector plate 80 may in one embodiment of the invention be equipped with an ROV (Remotely Operated Vehicle) handle. An ROV handle 110 is a grip means that an ROV, or any other suitable device, can engage with and may be defined using industry standards such as API 17 H. The ROV handle 110 may here be connected to the connector plate 80 in a direction parallel to the central longitudinal axis of the male-male hot stab assembly 10, and at a lateral distance from the central longitudinal axis of the male-male hot stab assembly 10.

This will facilitate movement of the male-male hot stab assembly 10 along its central longitudinal axis. FIGS. 1-4 schematically illustrate an example of a male-male hot stab assembly 10 where the connector is equipped with an ROV handle 110.

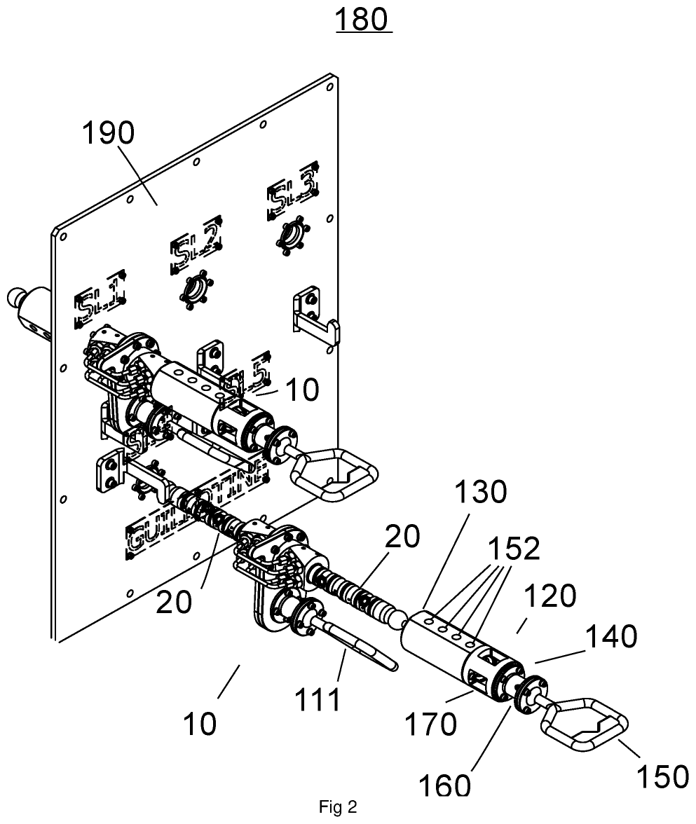

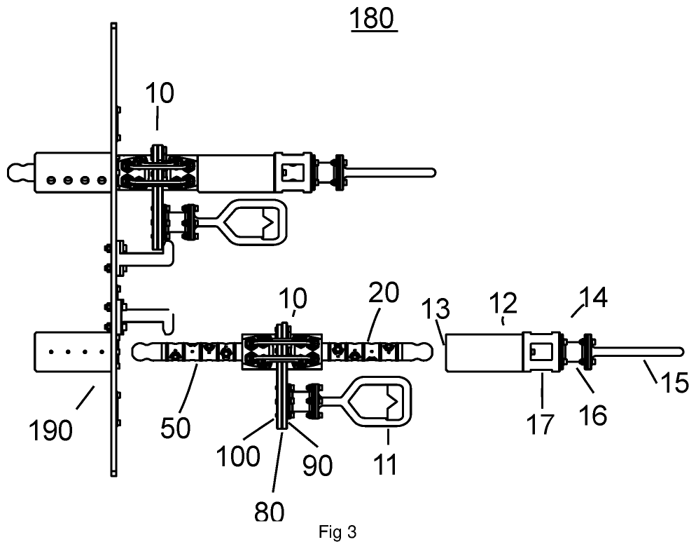

A second aspect of the invention relates to a flying receptacle, i.e. a receptacle that is not fixed to any installation. The flying receptacle is according to the invention removably connectable to the first hot stab 20, or second hot stab 50. The flying receptacle 110 has a first end 130 and a second end 140, where the first end 130 is configured to receive a hot stab. The flying receptacle 110 may here be a conventional receptacle not fixed to stationary subsea equipment, where the flying receptacle comprises a channel allowing the first hot stab 20 to be inserted into the flying receptacle 110. FIGS. 2 and 3 schematically illustrate a flying receptacle 110.

The receptacle second end may comprise ventilation means configured to facilitate the release of fluid from within the receptacle when a hot stab is received by the receptacle. The ventilation means may also be configured to release fluid pressure from within the receptacle when a hot stab is received by the receptacle.

The flying receptacle may according to one embodiment of the invention be provided with an ROV handle. An ROV handle is a grip means that a ROV, or any other suitable device, can engage with and may be defined using industry standards such as API 17 H. The ROV-handle may in the context of the present invention be connected to the receptacle second end.

The flying receptacle 110 may according to one embodiment of the invention further comprise a flex joint 160 connected between the ROV handle 150 and the receptacle second end 140. The flex joint 160 may here be used in order to limit stress and tension transfer between the ROV handle 150 and the receptacle. FIGS. 2 and 3 schematically illustrate an example of a flying receptacle 110 comprising a flex joint 160 connected between the ROV handle 150 and the receptacle second end 140.

A third aspect of the present invention relates to a subsea fluid connection system 180 comprising a subsea installation 190, a male-male hot stab assembly 10 and a flying receptacle 110. The subsea installation 190 and the flying receptacle 110 may here be connected to each of the two hot stabs in the hot stab assembly 10 respectively. The subsea installation 190 may here be any installation 190 suitable for receiving at least one hot stab, e.g. a production manifold or Christmas tree. The subsea installation 190 and the connector plate 80 can lockingly engage through locking means. The male-male hot stab assembly 10 may be fastened to the subsea installation 190 when the connector plate 80 lockingly engages with the subsea installation 190. Said locking means may e.g. be hook, as schematically illustrated in FIG. 2. A locking engagement between the male-male hot stab assembly 10 and the subsea installation 190 may thus, as schematically illustrated in FIG. 2, be obtained by rotating the male-male hot stab assembly 10 after the second hot stab has been inserted into the subsea equipment. When lockingly engaged, the second hot stab 50 is located inside the hot stab channel of the subsea installation 190. The second hot stab 50 is thereby secured inside the hot stab channel of the subsea installation 190. The flying receptacle 110 can then be removed from the first hot stab 20 to which it is connected whilst ensuring that the second hot stab 50 remains inside the hot stab channel of the subsea installation 190. This prevents accidental removal of the second hot stab 50 from the subsea installation 190 when removing the flying receptacle 110 form the first hot stab 20 or adjusting the flying receptacle 110. FIGS. 2 and 3 schematically illustrate an example of a subsea fluid connection system 180 comprising a subsea installation 190, a male-male hot stab assembly 10 and a flying receptacle 110.

The male-male hot stab assembly may be removed for maintenance whilst leaving the subsea installation and the flying receptacle behind. This may be performed e.g. using an ROV. To do so, an ROV can grippingly engage and remove the flying receptacle, which further may be stored in a suitable location while the male-male hot stab assembly is being brought to the surface for maintenance. Examples of types of maintenance needed may be the changing of O-rings. O-rings in a hot stab male body are known to be worn out over time and may eventually break. Such an O-ring failure may be critical for a subsea installation as it will allow for hydraulic fluid to flow between the different hydraulic fluid conduits.

One advantage of the present invention is that it allows for eased hot stab maintenance. Only the male-male hot stab assembly will have to be removed for maintenance, whilst the rest of the subsea installation may be left on the seabed. Conventional maintenance of hot stabs, e.g. changing of an O-ring, requires the removal of large installations from the subsea up to the surface. This is time consuming, complicated and not cost-effective. The solution of the male-male hot stab assembly that is removably connected to permanent installation is that it is much quicker, easier and more cost-effective to perform maintenance. The male-male hot stab assembly may also be replaced with a new male-male hot stab assembly.

Figure references:

Male-male hot stab assembly 10
First hot stab 20
First hot stab male front end 30
First hot stab base end 40
Second hot stab 50
Second hot stab male front end 60
Second hot stab base end 70
Fluid opening 71
Conduit 72
First hot stab base end fluid opening 73
Second hot stab base end fluid opening 74
Connector plate 80
Connector plate front face 90
Connector plate rear face 100
Connector plate fluid passage 101
First fluid passage opening 102
Second fluid passage opening 103
Seal 104
ROV handle 110
Flying receptacle 120
Receptacle first end 130
Receptacle second end 140
ROV handle 150
Flex joint 160
Spacer 170
Subsea fluid connection system 180
Subsea installation 190

1-16. (canceled)

17. A male-male hot stab assembly connectable to a flying receptacle, the male-male hot stab assembly comprising;
a first hot stab comprising a first hot stab male front end and a first hot stab base end, and
a second hot stab comprising a second hot stab male front end and a second hot stab base end,
where the first hot stab and second hot stab are connected to each other by connecting the first hot stab base end to the second hot stab base end.

18. The male-male hot stab assembly according to claim 17, where fluid connection between the first hot stab and the second hot stab is provided using conduits.

19. The male-male hot stab assembly according to claim 17, where
the first hot stab further comprises a first hot stab base end fluid opening, and
the second hot stab further comprises a second hot stab base end fluid opening,
wherein the first hot stab base end fluid opening is aligned with the second hot stab base end fluid opening.

20. The male-male hot stab assembly according to claim 17, further comprising a connector plate comprising a connector plate front face and a connector plate rear face, where the first hot stab and second hot stab are connected to each other by connecting the first hot stab base end to the second hot stab base end via the connector plate.

21. The male-male hot stab assembly according to claim 19, where
the connector plate is provided with a connector plate fluid passage that extends through the connector plate from a first fluid passage opening on the connector plate front face to a second fluid passage opening on the connector plate rear face, and where
the first and second connector plate fluid passage openings are aligned with the first hot stab base end fluid opening, and the second hot stab base end fluid opening respectively.

22. The male-male hot stab assembly according to claim 21, where the connector plate is provided with a fluid seal around the first fluid passage opening and a fluid seal around the second fluid passage opening.

23. The male-male hot stab assembly according to claim 17, further comprising an ROV handle.

24. The male-male hot stab assembly according to claim 20, further comprising an ROV handle, where the ROV handle is connected to the connector plate.

25. The male-male hot stab assembly according to claim 24, where
the connector plate extends in a lateral direction relative to a central longitudinal axis of the male-male hot stab assembly, and where
the ROV handle is connected to the connector plate in a direction parallel to the central longitudinal axis of the male-male hot stab assembly, and at a lateral distance from the central longitudinal axis of the male-male hot stab assembly.

26. A flying receptacle, configured to receive a first hot stab of a hot stab assembly according to claim 17, where the flying receptacle comprises
a receptacle first end, configured to receive a first hot stab,
a channel allowing the first hot stab to be inserted into the flying receptacle,
a receptacle second end, and
an ROV-handle.

27. The flying receptacle according to claim 26, further comprising ventilation means configured to release pressure from within the receptacle when a hot stab is received by the receptacle.

28. The flying receptacle according to claim 26, where the ROV-handle is connected to the receptacle second end.

29. The flying receptacle according to claim 26, further comprising a flex joint connected between the ROV-handle and the receptacle second end.

30. The flying receptacle (120) according to claim 28, further comprising a spacer provided between the ROV-handle and the receptacle second end, where the spacer is configured to release pressure from within the receptacle when a hot stab is received by the receptacle.

31. The flying receptacle according to claim 30, where the spacer has a tubular shape provided with at least one fluid passage.

32. A subsea fluid connection system comprising:
a subsea installation, comprising a fixed receptacle,
the male-male hot stab assembly according to claim 17, and
a flying receptacle, where the flying receptacle comprises
a receptacle first end, configured to receive a first hot stab,
a channel allowing the first hot stab to be inserted into the flying receptacle,
a receptacle second end, and
an ROV-handle,
where the second hot stab of the male-male hot stab assembly is configured to connect to the fixed receptacle and where the first hot stab of the male-male hot stab assembly is configured to connect to the flying receptacle.
